(19) United States
(12) Patent Application Publication
(10) Pub. No.: US 2026/0369197 A1
(43) Pub. Date: Nov. 19, 2026

(54) DISPLAY DEVICE AND ELECTRONIC DEVICE INCLUDING SAME

(71) Applicant: Samsung Display Co., Ltd., Yongin-si (KR)

(72) Inventors: Jaehoon SHIN, Yongin-si (KR); Jung-Taek KIM, Yongin-si (KR)

(73) Assignee: Samsung Display Co., Ltd., Yongin-si (KR)

(21) Appl. No.: 19/637,080

(22) Filed: Apr. 2, 2026

(30) Foreign Application Priority Data
May 19, 2025 (KR) 10-2025-0064687

(51) Int. Cl. G09G 3/00; G09G 3/3275

(52) U.S. Cl. CPC G09G 3/006; G09G 3/3275; G09G 2330/021; G09G 2330/12

(57) ABSTRACT

A display device includes pixels connected to at least one gate line extending in a first direction and at least one data line extending in a second direction different from the first direction, a data driver transmitting a data signal corresponding to each of the pixels through the at least one data line, a sensing circuit receiving a plurality of sensing signals output from the pixels through a plurality of sensing lines in response to the data signal, and a timing controller configured to control the data driver to perform a sensing operation to sense a characteristic of a selected pixel based on selection data that indicates the selected pixel corresponding to each of the at least one gate line. The pixels are connected to a first gate line, at least two pixels are connected to a sensing line and are adjacent to each other in the first direction.

### CROSS-REFERENCE TO RELATED APPLICATION

This U.S. non-provisional application claims priority under 35 U.S.C. § 119 to Korean Patent Application No. 10-2025-0064687 filed at the Korean Intellectual Property Office on May 19, 2025, the entire contents of which are incorporated herein by reference.

### BACKGROUND

Some example embodiments relate to a display device and an electronic device including the display device.

As information and communication technology advances, various types of images are distributed, and an amount of data processed to provide information of the images is increasing. It may be advantageous to use a relatively higher-performance display device to display the images. For example, a display device using an organic light emitting diode (OLED) may include a plurality of pixels including one organic light emitting diode and one transistor. Because characteristics of the transistor elements included in each pixel are different, brightnesses of the organic light emitting diodes may be different even if amounts of currents flowing through the organic light emitting diodes are relatively similar. Non-uniformity of luminance of the OLED display device may occur due to a deviation of a process (e.g., manufacturing process), a driving environment, a driving elapsed time, or the like. To reduce the non-uniformity of luminance, the OLED display uses an external compensation method that senses a characteristic of the pixel and compensates for a characteristic deviation between the pixels based on a sensing result.

### SUMMARY

Some example embodiments provide a display device configured to sense a characteristic of a pixel within a display panel.

According to some example embodiments, the display device includes a plurality of pixels connected to at least one gate line extending in a first direction and at least one data line extending in a second direction different from the first direction, a data driver configured to transmit a data signal corresponding to each of the plurality of pixels through the at least one data line, a sensing circuit configured to receive a plurality of sensing signals output from the plurality of pixels through a plurality of sensing lines in response to the data signal, and a timing controller configured to control the data driver to perform a sensing operation to sense a characteristic of a selected pixel based on selection data, the selection data indicating the selected pixel corresponding to each of the at least one gate line. The plurality of pixels are connected to a first gate line of the at least one gate line, at least two pixels of the plurality of pixels are connected to a sensing line, and the at least two pixels are adjacent to each other in the first direction.

According to some example embodiments, the display device includes a plurality of pixels that are connected to at least one gate line extending in a first direction, at least one data line extending in a second direction different from the first direction, and at least one sensing line extending in the second direction, the plurality of pixels being connected to a first gate line of the at least one gate line, and at least two pixels of the plurality of pixels being adjacent to each other in the first direction and being connected to the at least one sensing line, a timing controller configured to perform a sensing operation to sense a characteristic of a selected pixel based on selection data, the selection data indicating the selected pixel corresponding to each of the at least one gate line, and a data driver configured to transmit a first data signal corresponding to a first measurement criterion to the selected pixel based on the selection data and apply a second data signal corresponding to a black voltage to a plurality of non-selected pixels.

According to some example embodiments, an electronic device includes a display module that is connected to at least one gate line extending in a first direction, at least one data line extending in a second direction different from the first direction, and at least one sensing line extending in the second direction, the display module including a plurality of pixels connected to a first gate line of the at least one gate line, and at least two pixels of the plurality of pixels being adjacent each other in the first direction and being connected to the at least one sensing line, a memory configured to store selection data indicating a selected pixel corresponding to each of the at least one gate line, and a processor configured to transmit a first data signal corresponding to a first measurement criterion to the selected pixel based on the selection data and apply a second data signal corresponding to a black voltage to a plurality of non-selected pixels to perform a sensing operation to sense a characteristic of the selected pixel.

The display device, according to some example embodiments, may reduce a dimension (e.g., a length) of a side of a sensing circuit (e.g., a long side of the IC package including the sensing circuit) by reducing the number of sensing pads.

The display device, according to some example embodiments, may sense a characteristic of a pixel with a relatively higher accuracy by reducing or limiting or preventing defects in multiple adjacent pixels due to the presence of a switch.

### BRIEF DESCRIPTION OF THE DRAWINGS

FIG. 1 is a block diagram showing a display device according to some example embodiments.

FIG. 2 is a circuit diagram of a pixel according to some example embodiments.

FIG. 3 is a circuit diagram showing a sensing circuit according to some example embodiments.

FIG. 4 and FIG. 5 illustrate configurations of the display device, according to some example embodiments.

FIG. 6 and FIG. 7 illustrate configurations of the display device, according to some example embodiments.

FIG. 8 illustrates configurations of the display device, according to some example embodiments.

FIG. 9 is a block diagram of an electronic device according to some example embodiments.

FIGS. 10, 11, and 12 are schematic diagrams of electronic devices according to some example embodiments.

### DETAILED DESCRIPTION OF EXAMPLE EMBODIMENTS

Example embodiments of the present disclosure will be described hereinafter with reference to the accompanying drawings so that those skilled in the art could easily implement the embodiments. The present disclosure may be modified in various ways, all without departing from the spirit or scope of the present disclosure.

In order to describe the present disclosure, parts or portions that are irrelevant to the description are omitted, and identical or similar constituent elements throughout the specification are denoted by the same reference numerals.

In the drawings, a size and a thickness of each element are arbitrarily illustrated for ease of description, and example embodiments are not necessarily limited to what is illustrated in the drawings. In the drawings, the thicknesses of some layers and areas are exaggerated for clarity. In the drawings, for ease of description, the thicknesses of some layers and areas are exaggerated.

It should be understood that when an element such as a layer, a film, a region, or a plate is referred to as being “on” or “above” another element, it may be directly on the other element, or an intervening element may also be present. In contrast, when an element is referred to as being “directly on” another element, there are no intervening elements present. Further, in the specification, the word “on” or “above” means disposed on or below a referenced part, and does not necessarily mean disposed on the upper side of the referenced part based on a gravitational direction.

Unless explicitly stated to the contrary, the word “comprise” and variations such as “comprises” and “comprising” should be understood to imply the inclusion of stated elements but not the exclusion of any other elements.

Throughout the specification, the phrase “in a plan view” or “on a plane” may mean when an object portion is viewed from above, and the phrase “in a cross-sectional view” or “in a cross-section” may mean when a cross-section taken by vertically cutting an object portion is viewed from the side.

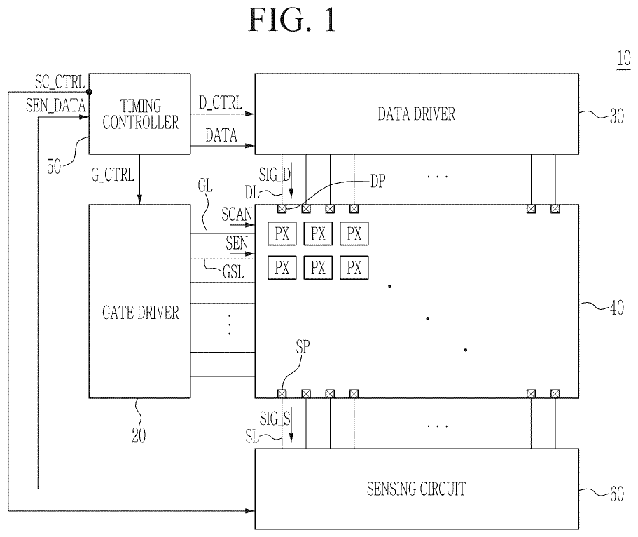

FIG. 1 is a block diagram showing a display device according to some example embodiments.

In some example embodiments, a display device 10 may be mounted on or installed in an electronic device having an image display function. For example, the electronic device may include a smartphone, a tablet personal computer, a portable multimedia player (PMP), a camera, a wearable device, a television, a digital video disk (DVD) player, a set-top box, a robot, a drone, various medical devices, a navigation device, a global positioning system (GPS) receiver, a vehicle device, various measuring devices, or the like.

The display device 10 may receive an input image signal from a host, and may display the input image signal. The host may be a graphics processor. However, example embodiments are not limited thereto, and the host may be or include other types of processors such as a central processing unit (CPU), a microprocessor, a multimedia processor, and an application processor. In some example embodiments, the host may be implemented as an integrated circuit (IC) or a system on chip (SoC).

The display device 10 may include a display panel 40 and a display panel driving portion that drives the display panel 40.

The display device 10 may display a two-dimensional image or a three-dimensional image to a user. In some example embodiments, the display device 10 may be a device in which the display panel driving portion and the display panel 40 are implemented as a single module. For example, the display panel driving portion may be installed on a substrate of the display panel 40, or the display panel driving portion and the display panel 40 may be electrically connected through a connection member such as a flexible printed circuit board (FPCB).

The display panel 40 may display an image to the user according to the input image signal. The display panel 40 may be a device that receives an electrically transferred image signal to display a two-dimensional image such as a thin film transistor-liquid crystal display (TFT-LCD), an organic light emitting diode (OLED) display, a field emission display, and a plasma display panel (PDP). In some example embodiments, the display device 10 may include one or more display panels 40.

The display panel 40 may include a plurality of signal lines, for example, a plurality of gate lines (GL), a plurality of gate sensing lines (GSL), a plurality of data lines (DL), and a plurality of sensing lines (SL). Additionally, the display panel 40 may include a plurality of pixels PX connected to the plurality of signal lines and disposed in a matrix form. The display panel 40 may display an image based on a data signal SIG_D received from a data driver 30 and a gate driving signal received from a gate driver 20.

In some example embodiments, the display panel 40 may include a pixel implemented using an organic light emitting diode (OLED) cell. The OLED cell may receive the data signal SIG_D via the data line DL and the gate driving signal via the gate line GL, and may perform an operation of displaying an image in response to an operation of an organic light emitting diode (OLED). However, example embodiments are not limited thereto, and the display panel 40 may be implemented as another type of flat panel display or flexible display panel.

The plurality of gate lines GL and the plurality of gate sensing lines GSL may extend in a first direction, and may be connected to pixels PX disposed along the first direction. For example, the gate line GL may transfer or transmit a scan control signal SCAN output from the gate driver 20 to an element (for example, a transistor) provided in the pixel PX. For example, the gate sensing line GSL may transfer or transmit a sensing control signal SEN output from the gate driver 20 to an element (for example, a transistor) provided in the pixel PX.

The plurality of data lines DL and the plurality of sensing lines SL may extend in a second direction intersecting the first direction, and may be connected to pixels PX disposed along the second direction. For example, the data line DL may transfer or transmit a data voltage (for example, a data signal SIG_D output from the data driver 30) to the pixel PX corresponding to the data line DL. For example, the sensing line SL may transfer or transmit a sensing signal SIG_S output from the pixel PX to a sensing circuit 60 by applying the data signal SIG_D to the pixel PX corresponding to the sensing line SL.

The display panel 40 may be connected through the data driver 30 and a data pad DP. The data pad DP may refer to a portion that is connected to the plurality of data lines DL to transfer the data signal SIG_D output from the data driver 30 to the pixel PX. The display panel 40 may be connected to the sensing circuit 60 through a sensing pad SP. The sensing pad SP may refer to a portion that is connected to the plurality of sensing lines SL to transfer the sensing signal SIG_S output from the pixel PX to the plurality of sensing lines SL.

In FIG. 1, the pixel PX is discussed as being connected to the gate line GL, the gate sensing line GSL, the data line DL, and the sensing line SL, but a connection structure (or configuration) of the signal lines of the pixel PX of the display device according to some example embodiments is not limited thereto. For example, a circuit structure of the pixel PX may include various other signal lines that may be connected to the pixel PX in addition to the gate line GL, the gate sensing line GSL, the data line DL, and the sensing line SL.

Referring to FIG. 1, the display panel driving portion may include a timing controller 50, the gate driver 20, the data driver 30, and the sensing circuit 60.

The timing controller 50 may control a driving timing of the display panel driving portion. The timing controller 50 may perform various image processing (e.g., changing of a format of image data and reducing of power consumption) on the input image signal.

The timing controller 50 may generate a data control signal D_CTRL. The timing controller 50 may generate image data DATA based on the input image signal. The timing controller 50 may transmit the data control signal D_CTRL and the image data DATA to the data driver 30.

The timing controller 50 may generate a gate control signal G_CTRL based on a control command (CTRL) and an input image signal (IS). The timing controller 50 may transmit the gate control signal G_CTRL to the gate driver 20.

In some example embodiments, the timing controller 50 may include selection information. The selection information may be information for indicating a selected pixel that will be a sensing target among the plurality of pixels. For example, the selection information may include the number of sensing times for performing a sensing operation and a sensing pattern according to each sensing order. The sensing pattern may be information indicating the pixel to be sensed for each of the plurality of gate lines. The timing controller 50 may generate the data control signal D_CTRL, the gate control signal G_CTRL, and the image data DATA based on the selection information.

In some example embodiments, the timing controller 50 may compensate for the data voltage that the data driver 30 applies to the display panel 40 in response to the input image signal based on a characteristic of each of the plurality of pixels. The characteristic of the pixel may be a value of an output current according to a voltage applied to the pixel. The characteristic of the pixel is not limited thereto, and may be a value of an output voltage according to the voltage applied to the pixel. In some example embodiments, the characteristic of the pixel may be information indicating a degradation degree for the pixel. For example, the characteristic of the pixel may include a degradation degree of an organic light emitting diode (OLED) or transistors included in the pixel.

The gate driver 20 may drive the plurality of gate lines GL of the display panel 40 based on the gate control signal G_CTRL received from the timing controller 50. The gate driver 20 may provide a gate voltage to each of the plurality of gate lines GL based on the gate control signal G_CTRL. For example, based on the gate control signal G_CTRL, the gate driver 20 may provide pulses of a gate-on voltage to the gate line GL corresponding to the gate control signal G_CTRL during a driving period corresponding to the gate control signal G_CTRL. The gate driver 20 may output the scan control signal SCAN to the display panel 40 through the plurality of gate lines GL.

The gate driver 20 may drive the plurality of gate sensing lines GSL of the display panel 40 based on the gate control signal G_CTRL received from the timing controller 50. The gate driver 20 may provide a sensing control voltage to each of the plurality of gate sensing lines GSL based on the gate control signal G_CTRL. For example, based on the gate control signal G_CTRL, the gate driver 20 may provide pulses of a sensing-on voltage to the gate sensing line GSL corresponding to the gate control signal G_CTRL during a driving period corresponding to the gate control signal G_CTRL. The gate driver 20 may output the sensing control signal SEN to the display panel 40 through the plurality of gate lines GL.

The data driver 30 may apply the data signal SIG_D corresponding to the input image signal to the display panel 40 under control of the timing controller 50.

The data driver 30 may receive the data control signal D_CTRL and the image data DATA from the timing controller 50. In some example embodiments, the data driver 30 may receive the image data DATA in data units corresponding to the plurality of pixels PX included in one horizontal line of the display panel 40. The image data DATA may include grayscale information corresponding to each pixel PX to display the input image signal (IS) on the display panel 40. The data driver 30 may process the image data DATA in synchronization with a clock signal received from the timing controller 50.

The data driver 30 may generate the data signal SIG_D based on the data control signal D_CTRL and the image data DATA. For example, the data driver 30 may generate the data signal SIG_D corresponding to a preset (or desired or given) measurement criterion based on the data control signal D_CTRL and the image data DATA. The preset measurement criterion may also be referred to as a first measurement criterion, which may be a desired or a given measurement criterion. The data driver 30 may apply the data signal SIG_D corresponding to the preset (or desired or given) measurement criterion to a selected pixel. The data driver 30 may generate the data signal SIG_D corresponding to a preset (or desired or given) black voltage based on the data control signal D_CTRL and the image data DATA. The data driver 30 may apply the data signal SIG_D corresponding to a preset (or desired or given) black voltage to a non-selected pixel. The black voltage may be a voltage level at which a driving transistor within the pixel is not turned on. The non-selected pixel may be pixels other than the selected pixel among the plurality of pixels that share the data line DL, the sensing line SL, the gate line GL, and the gate sensing line GSL connected to the selected pixel.

The sensing circuit 60 may receive the sensing signal SIG_S output from the display panel 40 under control of the timing controller 50.

The sensing circuit 60 may receive a sensing circuit control signal SC_CTRL from the timing controller 50. The sensing circuit control signal SC_CTRL may be a signal for controlling a component (e.g., a switch) within the sensing circuit 60. The sensing circuit 60 may receive the sensing signal SIG_S from the selected pixel based on the sensing circuit control signal SC_CTRL. The sensing signal SIG_S may be a signal output by the selected pixel in response to the data signal SIG_D applied to the selected pixel by the data driver 30. The sensing signal SIG_S may be a signal representing an electrical characteristic of the selected pixel.

The sensing circuit 60 may generate sensing data SEN_DATA based on the sensing signal SIG_S. The sensing data SEN_DATA may correspond to a size of a signal output from the selected pixel in response to applying the data signal SIG_D corresponding to the preset (or desired or given) measurement criterion to the selected pixel. For example, because the data signal SIG_D corresponding to the preset (or desired or given) black voltage is applied to the non-selected pixel, there may be no signal output from the non-selected pixel. The sensing circuit 60 may transmit the sensing data SEN_DATA to the timing controller 50.

In some example embodiments, the timing controller 50 may store the sensing data SEN_DATA received from the sensing circuit 60. Thereafter, the timing controller 50 may compensate for the data voltage applied to the display panel 40 by the data driver 30 based on the sensing data SEN_DATA received from the sensing circuit 60.

The display device 10 may perform a display operation and a sensing operation. In some example embodiments, when the display device 10 performs the display operation, the display device 10 may display an image corresponding to the input image signal received from an external source.

In some example embodiments, when the display device 10 performs the sensing operation, the timing controller 50 may generate the data control signal D_CTRL and the image data DATA based on the selection information. The data driver 30 may generate the data signal SIG_D based on the data control signal D_CTRL and the image data DATA. The sensing circuit 60 may receive the sensing signal SIG_S generated based on the data signal SIG_D from the selected pixel. The sensing circuit 60 may generate the sensing data SEN_DATA based on the sensing signal SIG_S. For example, the display device 10 may perform the sensing operation during a vertical blank period in which the display device 10 does not display the image. For example, because characteristics of elements included within the pixel may be changed over time, the display device 10 may perform the sensing operation every specific period to display the image with relative accuracy.

The number of the plurality of data lines DL and the number of the plurality of sensing lines SL may be different from each other. In FIG. 1, the data driver 30 and the sensing circuit 60 are illustrated as separate components, but example embodiments are not limited thereto, and the sensing circuit 60 may be disposed within the data driver 30 or the sensing circuit 60 and the data driver 30 may be formed in a single IC.

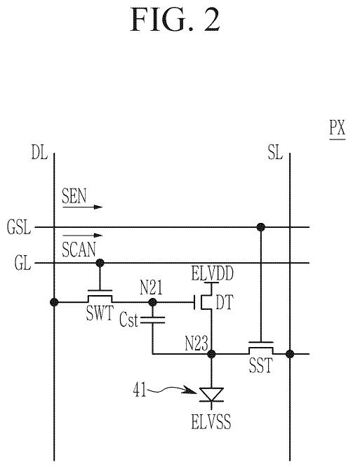

FIG. 2 is a circuit diagram of the pixel according to some example embodiments.

The display panel 40 of FIG. 1 may include a plurality of pixels PX. Each pixel PX of the plurality of pixels PX may include a plurality of sub-pixels.

As shown in FIG. 2, the pixel PX may include a switching transistor SWT, a driving transistor DT, an OLED 41, a storage capacitor Cst, and a sensing transistor SST. The switching transistor SWT, the driving transistor DT, the OLED 41, the storage capacitor Cst, and the sensing transistor SST may be any one of a PMOS transistor or an NMOS transistor. Although FIG. 2 illustrates a case in which all three transistors are formed of NMOS transistors, example embodiments are not limited thereto.

Although FIG. 2 illustrates that the pixel PX includes one sub-pixel for convenience of description, example embodiments are not limited thereto, and the pixel PX may include a plurality of sub-pixels. In this case, the pixel PX shown in FIG. 2 may include the switching transistor SWT, the driving transistor DT, the OLED 41, the storage capacitor Cst, and the sensing transistor SST that correspond to one sub-pixel.

A first driving voltage ELVDD and a second driving voltage ELVSS may be applied to the pixel PX. The first driving voltage ELVDD may be relatively higher than the second driving voltage ELVSS.

The pixel PX may be connected to the gate line GL, the gate sensing line GSL, the data line DL, and the sensing line SL corresponding to the pixel PX. Although FIG. 2 shows that one pixel PX is connected to one data line DL and one sensing line SL for convenience of description, a plurality of pixels connected to one gate line GL may be connected to one sensing line SL.

The switching transistor SWT may be connected to the gate line GL and the data line DL. The switching transistor SWT may be controlled by the scan control signal SCAN applied through the gate line GL. The switching transistor SWT that is turned on may provide the data signal SIG_D supplied through the data line DL to a gate node N21 of the driving transistor DT.

The sensing transistor SST may be connected to the gate sensing line GSL and the sensing line SL, and may be controlled by the sensing control signal SEN applied through the gate sensing line GSL. The sensing transistor SST that is turned on may supply an initialization voltage to a source node N23 of the driving transistor DT. Additionally, the sensing transistor SST that is turned on may transfer a voltage supplied to the source node N23 to the sensing line SL.

The storage capacitor Cst may store a difference between a voltage corresponding to the data signal SIG_D applied to the gate node N21 of the driving transistor DT through the switching transistor SWT and an initialization voltage supplied to the source node N23 of the driving transistor DT through the sensing transistor SST so that a constant driving voltage (e.g., a gate-source voltage of the driving transistor DT) is supplied to the driving transistor DT for a predetermined (or desired or given) period (e.g., one frame).

The first driving voltage ELVDD may be applied to a drain node of the driving transistor DT, and the driving transistor DT may supply a current proportional to the driving voltage (i.e., a difference between a voltage of the gate node N21 and a voltage of the source node N23 of the driving transistor DT) to the OLED 41.

The OLED 41 may include an anode connected to the source node N23 of the driving transistor DT, a cathode to which the second driving voltage ELVSS is applied, and an organic light emitting layer between the cathode and the anode. The cathode may be a common electrode shared by the plurality of pixels PX. When a driving current is supplied from the driving transistor DT, light may be generated from the organic light emitting layer of the OLED 41. An intensity of light may be proportional to the driving current.

In the display operation, the switching transistor SWT may supply a data signal (DS) applied through a data line (DL2k-1) to the driving transistor DT. In this case, the sensing transistor SST may be turned on. The current proportional to the driving voltage (i.e., the difference between the voltage of the gate node N21 and the voltage of the source node N23 of the driving transistor DT) may flow through the OLED 41. The OLED 41 may output light according to the driving current corresponding to the image data.

In the sensing operation, when the pixel PX is the selected pixel, the data driver 20 may apply the data signal SIG_D corresponding to the preset (or desired or given) measurement criterion through the data line DL. When the pixel PX is the non-selected pixel, the data driver 20 may apply the data signal SIG_D corresponding to the preset (or desired or given) black voltage through the data line DL. As the data signal SIG_D corresponding to the black voltage is applied, the difference between the voltage of the gate node N21 and the voltage of the source node N23 of the driving transistor DT may become less than 0.

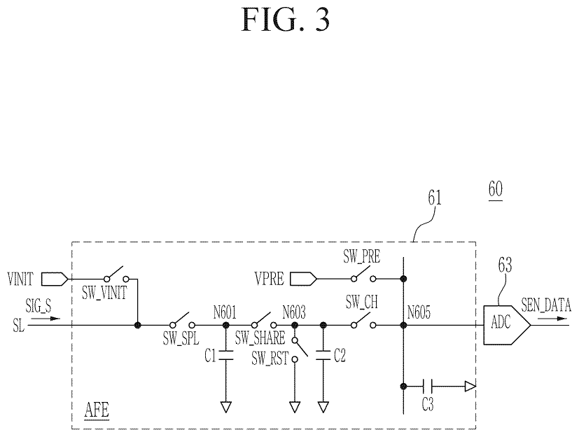

FIG. 3 is a circuit diagram showing the sensing circuit according to some example embodiments.

The sensing circuit 60 may include an analog front end (AFE) 61 and an analog-to-digital converter (ADC) 63.

The AFE 61 may transfer the sensing signal SIG_S received from the sensing line SL to the ADC 63. The AFE 61 may convert the sensing signal SIG_S into a sensing voltage based on the sensing circuit control signal SC_CTRL received from the timing controller 50, and may sample and hold the converted sensing voltage.

Referring to FIG. 3, the AFE 61 may include an initialization switch SW_VINIT, a sampling switch SW_SPL, a first capacitor C1, a sharing switch SW_SHARE, a reset switch SW_RST, a second capacitor C2, an output switch SW_CH, a precharge switch SW_PRE, and a third capacitor C3. The initialization switch SW_VINIT, the sampling switch SW_SPL, the sharing switch SW_SHARE, the reset switch SW_RST, the output switch SW_CH, and the precharge switch SW_PRE may be controlled based on the sensing circuit control signal SC_CTRL.

The initialization switch SW_VINIT may be connected between a power source line to which an initialization voltage VINIT is applied and the sensing line SL. The initialization voltage VINIT may be provided from a power source voltage supply circuit, and may have a voltage level lower than a voltage capable of operating the OLED 41. When the initialization switch SW_VINIT is turned on, the initialization voltage VINIT may be applied to the sensing line SL, and when the sensing transistor SST of the pixel PX is turned on, the initialization voltage VINIT may be applied to the source node N23 of the pixel PX. Because the initialization voltage VINIT has a voltage level lower than the voltage capable of operating the OLED 41, the OLED 41 may not emit light even if the driving transistor DT is turned on.

The sampling switch SW_SPL may be connected between the initialization switch SW_VINIT and a third node N603.

The first capacitor C1 may be connected between a first node N601 and a reference power source (e.g., a ground voltage). When the sampling switch SW_SPL is turned on, the first capacitor C1 may sample the sensing signal SIG_S. For example, the data driver 30 may sample the sensing signal SIG_S through the sampling switch SW_SPL and the first capacitor C1.

The sharing switch SW_SHARE may be connected between the first node N601 and the third node N603.

The reset switch SW_RST may be connected between the third node N603 and the reference power source (e.g., a ground voltage). When the reset switch SW_RST is turned on, an electric charge remaining at the third node N603 may be removed.

The second capacitor C2 may be connected between the third node N603 and the reference power source (e.g., a ground voltage). When the sharing switch SW_SHARE is turned on and the first capacitor C1 and the second capacitor C2 share an electric charge, a voltage of the first node N601 and a voltage of the third node N603 may be changed. The sharing switch SW_SHARE, the reset switch SW_RST, and the second capacitor C2 may function as buffers according to operations of the sharing switch SW_SHARE and the reset switch SW_RST.

The output switch SW_CH may be connected between the third node N603 and a fifth node N605. A voltage of the fifth node N605 may be applied to the ADC 63.

The precharge switch SW_PRE may be connected between a power line to which a precharge voltage VPRE is applied and the sensing line SL. The precharge voltage VPRE may be provided from the power source voltage supply circuit. If the precharge switch SW_PRE is turned on, the precharge voltage VPRE may be applied to the fifth node N605 so that the fifth node N605 is precharged with the precharge voltage VPRE.

The third capacitor C3 may be connected between the fifth node N605 and the reference power source (e.g., a ground voltage). Each of the first capacitor C1 and the third capacitor C3 may be set to have a value capable of achieving impedance matching by considering a capacitance value of the second capacitor C2 and a capacitance value of the sensing line SL.

The reference power source may be a ground voltage, but example embodiments are not limited thereto.

The ADC 63 may convert a signal of the sensing line SL, for example, the sensing voltage SIG_S from an analog signal to a digital signal and may output the converted digital signal as the sensing data SEN_DATA. For example, the ADC 63 may divide a range between a maximum reference voltage and a minimum reference voltage into a plurality of ranges. The ADC 63 may generate the sensing data SEN_DATA corresponding to a range to which a signal received from the AFE 61 belongs. The ADC 63 may transfer the sensing data SEN_DATA to the timing controller 50.

In the sensing step, the switching transistor SWT may apply the reference voltage to the gate node N21 in response to the scan control signal SCAN, and the sensing transistor SST may apply the initialization voltage to the source node N23 in response to the sensing control signal SEN. In this case, the initialization switch SW_VINIT may be turned off. The sensing transistor SST may apply a signal of the source node N23 to the sensing line SL. In this case, the initialization switch SW_VINIT may be turned on. The sensing circuit 60 may receive the signal of the sensing line SL (i.e., the signal of the source node N23), and may output the sensing data SEN_DATA.

In the driving step, the sensing transistor SST may apply the initialization voltage to the source node N23 in response to a sensing signal SIG_S. In this case, the initialization switch SW_VINIT may be turned off. Accordingly, a first electrode (i.e., an anode electrode) of the OLED 41 may be initialized. The data driver 30 may apply the data voltage to the data line DL through an amplifier. The switching transistor SWT may apply the reference voltage to the gate node N21 in response to the scan control signal SCAN. The data voltage applied to the gate node N21 may be written to the storage capacitor Cst. The driving transistor DT may generate a driving current corresponding to the voltage of the gate node N21. The driving current may be applied to the OLED 41, and the OLED 41 may emit light with a luminance according to the driving current.

During the sensing operation, the AFE 61 may precharge the sensing line SL to a predetermined voltage level by supplying the precharge voltage VPRE in advance. For example, to supply the precharge voltage VPRE to the sensing line SL, the precharge switch SW_PRE, the sampling switch SW_SPL, the sharing switch SW_SHARE, and the output switch SW_CH may all be connected or closed.

Thereafter, the AFE 61 may separate the sensing line SL and the AFE 61 from each other to float the sensing line SL. For example, at least one of the sampling switch SW_SPL, the sharing switch SW_SHARE, and the output switch SW_CH may be opened.

Next, the AFE 61 may measure a voltage value or a current value through the sensing line SL by connecting the sensing line SL and the AFE 61. For example, the sampling switch SW_SPL, the sharing switch SW_SHARE, and the output switch SW_CH may all be connected or closed. In this case, the precharge switch SW_PRE and the reset switch SW_RST may not be connected or may be open.

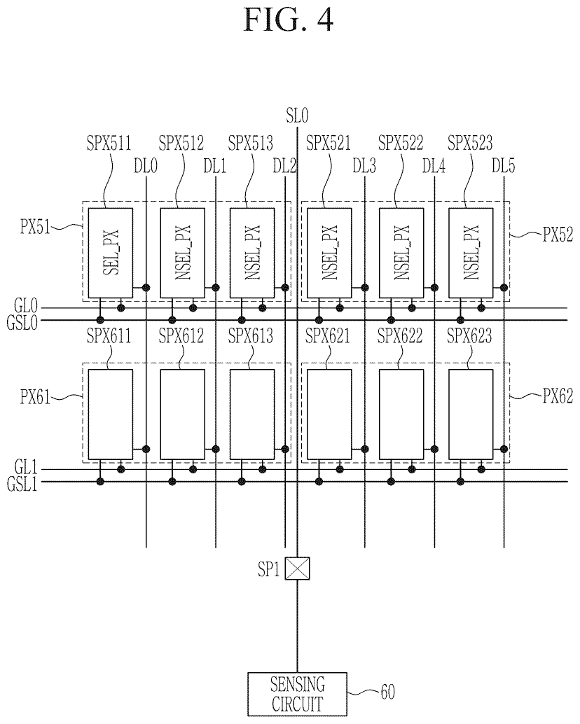

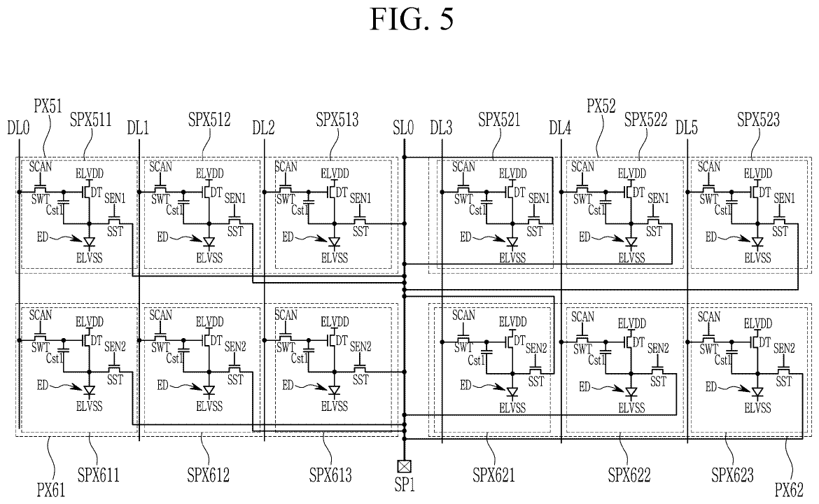

FIG. 4 and FIG. 5 illustrate configurations of the display device, according to some example embodiments. For example, FIG. 4 illustrates the sensing circuit 60 connected to a plurality of pixels PX51, PX52, PX61, and PX62. FIG. 5 illustrates a circuit of each of the plurality of pixels PX51, PX52, PX61, and PX62.

Referring to FIG. 4 and FIG. 5, each of the plurality of pixels PX51, PX52, PX61, and PX62 may include three sub-pixels. For example, a first pixel PX51 may include a plurality of sub-pixels SPX511, SPX512, and SPX513. A second pixel PX52 may include a plurality of sub-pixels SPX521, SPX522, and SPX523. A third pixel PX61 may include a plurality of sub-pixels SPX611, SPX612, and SPX613. A fourth pixel PX62 may include a plurality of sub-pixels SPX621, SPX622, and SPX623. The sub-pixels of each of the first pixel PX51, the second pixel PX52, the third pixel PX61, and the fourth pixel PX62 may be disposed in an order of a first color, a second color, and a third color. For example, a plurality of sub-pixels SPX511, SPX521, SPX611, and SPX621 may emit light with the first color, a plurality of sub-pixels SPX512, SPX522, SPX612, and SPX622 may emit light with the second color, and a plurality of sub-pixels SPX513, SPX523, SPX613, and SPX623 may emit light with the third color. The first color, the second color, and the third color may be red, green, and blue, respectively. Example embodiments are not limited thereto, and the first color, the second color, and the third color may be a combination of other colors as long as white light may be implemented or emitted or produced by the combination of the other colors.

As illustrated in FIG. 5, each of a plurality of sub-pixels SPX511, SPX512, SPX513, SPX521, SPX522, SPX523, SPX611, SPX612, SPX613, SPX621, SPX622, and SPX623 may include the switching transistor SWT, the driving transistor DT, the sensing transistor SST, a storage capacitor Cst1, and the OLED 41. A connection relationship between the switching transistor SWT, the driving transistor DT, the sensing transistor SST, the storage capacitor Cst1, and the OLED 41 may be the same as or similar in some respects to that of the pixel PX illustrated in FIG. 2.

A plurality of sub-pixels SPX511, SPX512, SPX513, SPX521, SPX522, and SPX523 within the first pixel PX51 and the second pixel PX52 may be connected to a first gate line GL0 and a first gate sensing line GSL0. A plurality of sub-pixels SPX611, SPX612, SPX613, SPX621, SPX622, and SPX623 within the third pixel PX61 and the fourth pixel PX62 may be connected to a second gate line GL1 and a second gate sensing line GSL1. Referring to FIG. 5, a gate of the switching transistor SWT included in each of the sub-pixels SPX511, SPX512, SPX513, SPX521, SPX522, and SPX523 may be electrically connected to the first gate line GL0, and a gate of the sensing transistor SST may be electrically connected to the first gate sensing line GSL0. A gate of the switching transistor SWT included in each of the sub-pixels SPX611, SPX612, SPX613, SPX621, SPX622, and SPX623 may be electrically connected to the second gate line GL1, and a gate of the sensing transistor SST may be electrically connected to the second gate sensing line GSL1.

Each of the plurality of sub-pixels within the first pixel PX51, the second pixel PX52, the third pixel PX61, and the fourth pixel PX62 may be connected to the data line corresponding to each of the plurality of sub-pixels.

The sub-pixel SPX511 within the first pixel PX51 and the sub-pixel SPX611 within the third pixel PX61 may be connected to a first data line DL0. The sub-pixel SPX512 within the second pixel PX52 and the sub-pixel SPX612 within the third pixel PX61 may be connected to a second data line DL1. The sub-pixel SPX513 within the first pixel PX51 and the sub-pixel SPX613 within the third pixel PX61 may be connected to a third data line DL2. The sub-pixel SPX521 within the second pixel PX52 and the sub-pixel SPX621 within the fourth pixel PX62 may be connected to a fourth data line DL3. The sub-pixel SPX522 within the second pixel PX52 and the sub-pixel SPX622 within the fourth pixel PX62 may be connected to a fifth data line DL4. The sub-pixel SPX523 within the second pixel PX52 and the sub-pixel SPX623 within the fourth pixel PX62 may be connected to a sixth data line DL5.

Referring to FIG. 5, one end of the switching transistor SWT included in each of the sub-pixels SPX511 and SPX611 may be electrically connected to the first data line DL0. One end of the switching transistor SWT included in each of the sub-pixels SPX512 and SPX612 may be electrically connected to the second data line DL1. One end of the switching transistor SWT included in each of the sub-pixels SPX513 and SPX613 may be electrically connected to the third data line DL2. One end of the switching transistor SWT included in each of the sub-pixels SPX521 and SPX621 may be electrically connected to the fourth data line DL3. One end of the switching transistor SWT included in each of the sub-pixels SPX522 and SPX622 may be electrically connected to the fifth data line DL4. One end of the switching transistor SWT included in each of the sub-pixels SPX523 and SPX623 may be electrically connected to the sixth data line DL5.

The plurality of sub-pixels within the first pixel PX51, the second pixel PX52, the third pixel PX61, and the fourth pixel PX62 may all be connected to a first sensing line SL0.

The sensing transistor SST included in each of the sub-pixels SPX511, SPX512, SPX513, SPX521, SPX522, SPX523, SPX611, SPX612, SPX613, SPX621, SPX622, and SPX623 may be electrically connected to the first sensing line SL0.

The first sensing line SL0 may be connected to the sensing circuit 60 through a first sensing pad SP1.

During the sensing operation, the data driver 30 may apply the data signal SIG_D corresponding to the preset measurement criterion to the selected pixel based on the data control signal D_CTRL. For example, the selection information may indicate the sub-pixel SPX511 as a selected pixel SEL_PX for the first gate line GL0. The data driver 30 may apply the data signal SIG_D corresponding to the measurement criterion to the selected pixel SEL_PX through the first data line DL0 based on the selection information, and may apply the data signal SIG_D corresponding to the black voltage to a non-selected pixel NSEL_PX (e.g., each of the sub-pixels SPX512, SPX513, SPX521, SPX522, and SPX523) through the data line corresponding to the data signal SIG_D. Accordingly, a data electric charge corresponding to the measurement criterion may be stored in the storage capacitor Cst of the sub-pixel SPX511, which is the selected pixel SEL_PX. Additionally, a difference between a voltage of a gate node and a voltage of a source node of the driving transistor DT of the non-selected pixel NSEL_PX may be less than 0. Thereafter, the gate driver 20 may perform the sensing operation of the selected pixel SEL_PX of the first gate line GL0 using a sensing control signal SEN1. The sensing transistor SST of each of the first pixel PX51 and the second pixel PX52 may be turned on by the sensing control signal SEN1 of an enable level, and the data electric charge corresponding to the measurement criterion stored in the storage capacitor Cst of the selected pixel SEL_PX may be transferred to the first sensing line SL0 as the sensing signal SIG_S through the sensing transistor SST. In this case, because the driving transistor DT of the non-selected pixel NSEL_PX does not operate, only the sensing signal SIG_S by the selected pixel SEL_PX may be transferred to the first sensing line SL0. The sensing signal SIG_S may be directly transferred to the sensing circuit 60 through the first sensing pad SP1.

The sensing circuit 60 may sense a characteristic of the selected pixel SEL_PX based on the sensing signal SIG_S generated based on an electric current flowing through the selected pixel SEL_PX. The sensing circuit 60 may generate the sensing data SEN_DATA based on the sensing signal SIG_S, and may transfer the sensing data SEN_DATA to the timing controller 50. The timing controller 50 may generate the data control signal D_CTRL that controls the data driver 30 to apply the data signal SIG_D corresponding to the measurement criterion to a selected pixel for a gate line (e.g., the second gate line GL1) adjacent to the first gate line GL0 based on the selection information. The timing controller 50 may obtain the sensing data SEN_DATA corresponding to the plurality of sub-pixels within the plurality of pixels PX of the display panel 40 by sequentially repeating the sensing. For example, the number of sensing times during the sensing operation may be six in the selection information, and the sub-pixel disposed in a first column for each of the plurality of gate lines may be sensed as the selected pixel during first sensing, the sub-pixel disposed in a second column for each of the plurality of gate lines may be sensed as the selected pixel during second sensing, and this may be sequentially repeated so that the sub-pixel disposed in a sixth column for each of the plurality of gate lines is sensed as the selected pixel during sixth sensing.

Although FIG. 4 and FIG. 5 illustrate that the sub-pixel SPX511 is the selected pixel SEL_PX, example embodiments are not limited thereto, and any (or all) of the sub-pixels may be selected pixels SEL_PX.

Conventionally, a separate switch was disposed between a plurality of sensing lines and a sensing circuit, and selection of a sensing signal was performed through a control of the switch. Defects could occur in adjacent pixels due to the separate switch, and the sensing signal could be affected by adjacent sensing lines.

However, in the display panel 40 according to some example embodiments, the plurality of sensing lines SL may be directly connected to the sensing circuit 60 without a separate switch so that a length of a long side of the sensing circuit 60 is shortened. In addition, a data signal applied to the selected pixel SEL_PX may be distinguished from a data signal applied to the non-selected pixel NSEL_PX so that the sensing signal is not affected by adjacent signals and the sensing signal for the selected pixel SEL_PX is read without the switch.

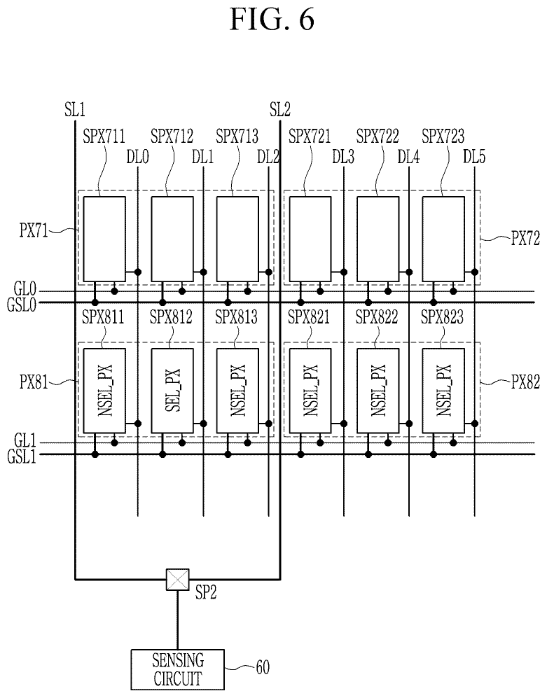

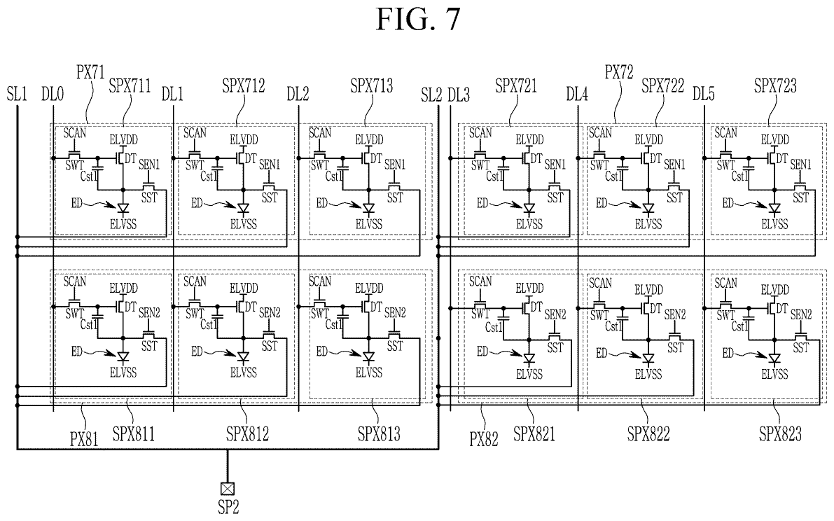

FIG. 6 and FIG. 7 illustrate configurations of the display device, according to some example embodiments. For example, FIG. 6 illustrates the sensing circuit 60 connected to a plurality of pixels PX71, PX72, PX81, and PX82. FIG. 7 illustrates a circuit of each of the pixels PX71, PX72, PX81, and PX82.

Referring to FIGS. 6 and 7, each of the plurality of pixels PX71, PX72, PX81, and PX82 may include three sub-pixels. For example, a first pixel PX71 may include a plurality of sub-pixels SPX711, SPX712, and SPX713. A second pixel PX72 may include a plurality of sub-pixels SPX721, SPX722, and SPX723. A third pixel PX81 may include a plurality of sub-pixels SPX811, SPX812, and SPX813. A fourth pixel PX82 may include a plurality of sub-pixels SPX821, SPX822, and SPX823.

As illustrated in FIG. 7, each of a plurality of sub-pixels SPX711, SPX712, SPX713, SPX721, SPX722, SPX723, SPX811, SPX812, SPX813, SPX821, SPX822, and SPX823 may include the switching transistor SWT, the driving transistor DT, the sensing transistor SST, the storage capacitor Cst1, and the OLED 41. A connection relationship between the switching transistor SWT, the driving transistor DT, the sensing transistor SST, the storage capacitor Cst1, and the OLED 41 may be the same as or similar in some respects to that of the pixel PX illustrated in FIG. 2.

A plurality of sub-pixels SPX711, SPX712, SPX713, SPX721, SPX722, and SPX723 within the first pixel PX71 and the second pixel PX72 may be connected to the first gate line GL0 and the first gate sensing line GSL0. A plurality of sub-pixels SPX811, SPX812, SPX813, SPX821, SPX822, and SPX823 within the third pixel PX81 and the fourth pixel PX82 may be connected to the second gate line GL1 and the second gate sensing line GSL1. Referring to FIG. 7, a gate of the switching transistor SWT included in each of the plurality of sub-pixels SPX711, SPX712, SPX713, SPX721, SPX722, and SPX723 may be electrically connected to the first gate line GL0, and a gate of the sensing transistor SST may be electrically connected to the first gate sensing line GSL0. A gate of the switching transistor SWT included in each of the sub-pixels SPX811, SPX812, SPX813, SPX821, SPX822, and SPX823 may be electrically connected to the second gate line GL1, and a gate of the sensing transistor SST may be electrically connected to the second gate sensing line GSL1.

Each of the plurality of sub-pixels within the first pixel PX71, the second pixel PX72, the third pixel PX81, and the fourth pixel PX82 may be connected to the data line corresponding to each of the plurality of sub-pixels.

The sub-pixel SPX711 within the first pixel PX71 and the sub-pixel SPX811 within the third pixel PX81 may be connected to the first data line DL0. The sub-pixel SPX712 within the second pixel PX72 and the sub-pixel SPX812 within the third pixel PX81 may be connected to the second data line DL1. The sub-pixel SPX713 within the first pixel PX71 and the sub-pixel SPX813 within the third pixel PX81 may be connected to the third data line DL2. The sub-pixel SPX721 within the second pixel PX72 and the sub-pixel SPX821 within the fourth pixel PX82 may be connected to the fourth data line DL3. The sub-pixel SPX722 within the second pixel PX72 and the sub-pixel SPX822 within the fourth pixel PX82 may be connected to the fifth data line DL4. The sub-pixel SPX723 within the second pixel PX72 and the sub-pixel SPX823 within the fourth pixel PX82 may be connected to the sixth data line DL5.

Referring to FIG. 7, one end of the switching transistor SWT included in each of the sub-pixels SPX711 and SPX811 may be electrically connected to the first data line DL0. One end of the switching transistor SWT included in each of the sub-pixels SPX712 and SPX812 may be electrically connected to the second data line DL1. One end of the switching transistor SWT included in each of the sub-pixels SPX713 and SPX813 may be electrically connected to the third data line DL2. One end of the switching transistor SWT included in each of the sub-pixels SPX721 and SPX821 may be electrically connected to the fourth data line DL3. One end of the switching transistor SWT included in each of the sub-pixels SPX722 and SPX822 may be electrically connected to the fifth data line DL4. One end of the switching transistor SWT included in each of the sub-pixels SPX723 and SPX823 may be electrically connected to the sixth data line DL5.

The plurality of sub-pixels within the first pixel PX71 and the third pixel PX81 may all be connected to a second sensing line SL1. The plurality of sub-pixels within the second pixel PX72 and the fourth pixel PX82 may all be connected to a third sensing line SL2.

The sensing transistor SST included in each of the sub-pixels SPX711, SPX712, SPX713, SPX811, SPX812, and SPX813 may be electrically connected to the second sensing line SL1. The sensing transistor SST included in each of the sub-pixels SPX721, SPX722, SPX723, SPX821, SPX822, and SPX823 may be electrically connected to the third sensing line SL2.

The second sensing line SL1 and the third sensing line SL2 may be connected to the sensing circuit 60 through a second sensing pad SP2. The second sensing line SL1 and the third sensing line SL2 may be directly connected to the sensing circuit 60.

During the sensing operation, the data driver 30 may apply the data signal SIG_D corresponding to the preset measurement criterion to the selected pixel based on the data control signal D_CTRL. For example, the selection information may indicate the sub-pixel SPX812 as a selected pixel SEL_PX for the second gate line GL1. The data driver 30 may apply the data signal SIG_D corresponding to the measurement criterion to the selected pixel SEL_PX through the second data line DL1 based on the selection information, and may apply the data signal SIG_D corresponding to the black voltage to a non-selected pixel NSEL_PX (e.g., each of the sub-pixels SPX811, SPX813, SPX821, SPX822, and SPX823) through the data line corresponding to the data signal SIG_D. Accordingly, a data electric charge corresponding to the measurement criterion may be stored in the storage capacitor Cst of the sub-pixel SPX812 that is the selected pixel SEL_PX. Additionally, a difference between a voltage of a gate node and a voltage of a source node of the driving transistor DT of the non-selected pixel NSEL_PX may be less than 0. Thereafter, the gate driver 20 may perform the sensing operation of the selected pixel SEL_PX of the second gate line GL1 using a sensing control signal SEN2. The sensing transistor SST of each of the third pixel PX81 and the fourth pixel PX82 may be turned on by the sensing control signal SEN2 of an enable level, and the data electric charge corresponding to the measurement criterion stored in the storage capacitor Cst of the selected pixel SEL_PX may be transferred to the second sensing line SL1 as the sensing signal SIG_S through the sensing transistor SST. In this case, because the driving transistor DT of the non-selected pixel NSEL_PX does not operate, only the sensing signal SIG_S by the selected pixel SEL_PX may be transferred to the second sensing line SL1 and the third sensing line SL2. The sensing signal SIG_S may be directly transferred to the sensing circuit 60 through the second sensing pad SP2.

The sensing circuit 60 may sense a characteristic of the selected pixel SEL_PX based on the sensing signal SIG_S generated based on an electric current flowing through the selected pixel SEL_PX. The sensing circuit 60 may generate the sensing data SEN_DATA based on the sensing signal SIG_S, and may transfer the sensing data SEN_DATA to the timing controller 50. The timing controller 50 may generate the data control signal D_CTRL that controls the data driver 30 to apply the data signal SIG_D corresponding to the measurement criterion to a selected pixel for a next gate line (e.g., a third gate line) based on the selection information. The timing controller 50 may obtain the sensing data SEN_DATA corresponding to the plurality of sub-pixels within the plurality of pixels PX of the display panel 40 by sequentially repeating the sensing.

Although FIG. 6 and FIG. 7 illustrate that the sub-pixel SPX812 is the selected pixel SEL_PX, example embodiments are not limited thereto, and any (or all) of the sub-pixels may be the selected pixels SEL_PX.

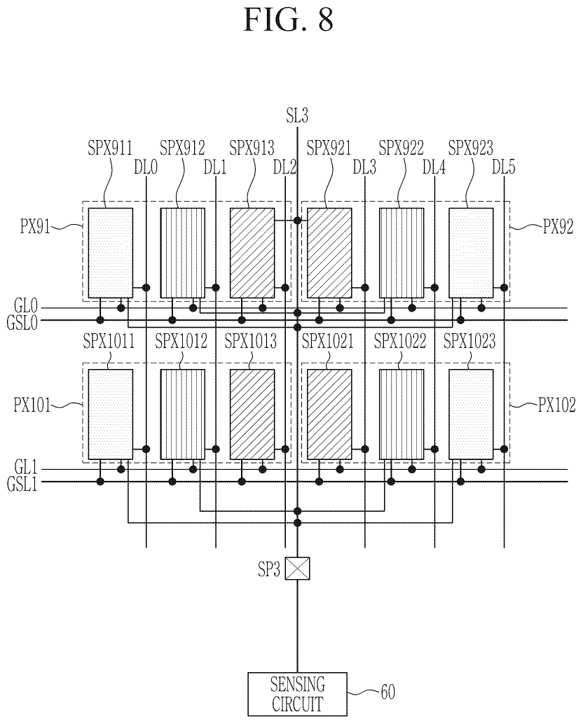

FIG. 8 illustrates configurations of the display device, according to some example embodiments. For example, FIG. 8 is a view illustrating the sensing circuit 60 connected to a plurality of pixels PX91, PX92, PX101, and PX102. The plurality of pixels PX51, PX52, PX61, and PX62 described with reference to FIG. 4 and FIG. 5 may be the same as or similar in some respects to the plurality of pixels PX91, PX92, PX101, and PX102 and therefore may be best understood with reference thereto.

Referring to FIG. 8, each of the plurality of pixels PX91, PX92, PX101, and PX102 may include three sub-pixels. For example, a first pixel PX91 may include a plurality of sub-pixels SPX911, SPX912, and SPX913. A second pixel PX92 may include a plurality of sub-pixels SPX921, SPX922, and SPX923. A third pixel PX101 may include a plurality of sub-pixels SPX1011, SPX1012, and SPX1013. A fourth pixel PX102 may include a plurality of sub-pixels SPX1021, SPX1022, and SPX1023.

In some example embodiments, the sub-pixels of each of the first pixel PX91, the second pixel PX92, the third pixel PX101, and the fourth pixel PX102 may be disposed symmetrically left and right with respect to a fourth sensing line SL3. For example, the sub-pixel SPX911 of the first pixel PX91 and the sub-pixel SPX923 of the second pixel PX92 disposed on opposite sides with respect to the fourth sensing line SL3 may emit light of a first color. The sub-pixel SPX912 of the first pixel PX91 and the sub-pixel SPX922 of the second pixel PX92 disposed on opposite sides with respect to the fourth sensing line SL3 may emit light of a second color. The sub-pixel SPX913 of the first pixel PX91 and the sub-pixel SPX921 of the second pixel PX92 disposed on opposite sides with respect to the fourth sensing line SL3 may emit light of a third color. Similarly, the sub-pixel SPX1011 and the sub-pixel SPX1023 may emit light of the first color, the sub-pixel SPX1012 and the sub-pixel SPX1022 may emit light of the second color, and the sub-pixel SPX1013 and the sub-pixel SPX1021 may emit light of the third color. The first color, the second color, and the third color may be red, green, and blue, respectively. Example embodiments are not limited thereto, and the first color, the second color, and the third color may be a combination of other colors as long as white light may be produced or generated by the combination of the other colors.

The plurality of sub-pixels SPX911, SPX912, SPX913, SPX921, SPX922, and SPX923 within the first pixel PX91 and the second pixel PX92 may be connected to the first gate line GL0 and the first gate sensing line GSL0. The plurality of sub-pixels SPX1011, SPX1012, SPX1013, SPX1021, SPX1022, and SPX1023 within the third pixel PX101 and the fourth pixel PX102 may be connected to the second gate line GL1 and the second gate sensing line GSL1.

Each of the plurality of sub-pixels within the first pixel PX91, the second pixel PX92, the third pixel PX101, and the fourth pixel PX102 may be connected to the data line corresponding to each of the plurality of sub-pixels.

The sub-pixel SPX911 within the first pixel PX91 and the sub-pixel SPX1011 within the third pixel PX101 may be connected to the first data line DL0. The sub-pixel SPX912 within the first pixel PX91 and the sub-pixel SPX1012 within the third pixel PX101 may be connected to the second data line DL1. The sub-pixel SPX913 within the first pixel PX91 and the sub-pixel SPX1013 within the third pixel PX101 may be connected to the third data line DL2. The sub-pixel SPX921 within the second pixel PX92 and the sub-pixel SPX1021 within the fourth pixel PX102 may be connected to the fourth data line DL3. The sub-pixel SPX922 within the second pixel PX92 and the sub-pixel SPX1022 within the fourth pixel PX102 may be connected to the fifth data line DL4. The sub-pixel SPX923 within the second pixel PX92 and the sub-pixel SPX1023 within the fourth pixel PX102 may be connected to the sixth data line DL5.

The plurality of sub-pixels within the first pixel PX91, the second pixel PX92, the third pixel PX101, and the fourth pixel PX102 may all be connected to the fourth sensing line SL3.

The fourth sensing line SL3 may be connected to the sensing circuit 60 through a third sensing pad SP3.

The plurality of sub-pixels of each of the plurality of pixels PX91, PX92, PX101, and PX102 may be disposed symmetrically left and right for each color with respect to the fourth sensing line SL3. Accordingly, there may be a reduction in the influence of parasitic capacitance between each sub-pixel and the fourth sensing line SL3. The sensing circuit 60 may improve reliability and accuracy by reducing an imbalance of sensing data for each color and an error due to the parasitic capacitance through RGB pixel disposition.

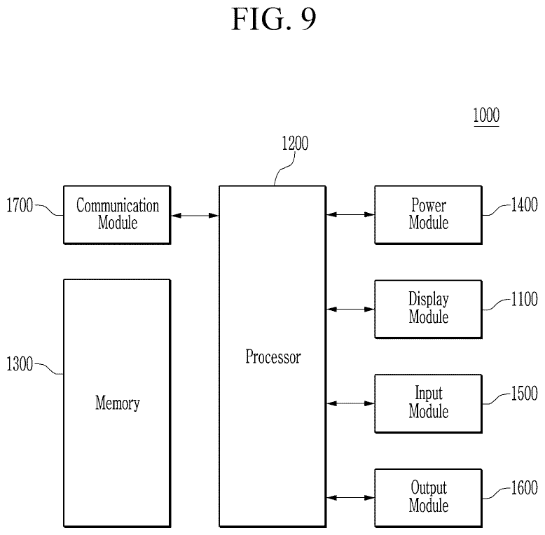

FIG. 9 is a block diagram of the electronic device according to some example embodiments.

Referring to FIG. 9, an electronic device 1000, according to some example embodiments, may include a display module 1100, a processor 1200, a memory 1300, and a power source module (or a power module) 1400.

The processor 1200 may include at least one of a central processing unit (CPU), an application processor (AP), a graphics processing unit (GPU), a communication processor (CP), an image signal processor (ISP), and a controller. In some example embodiments, the processor 1200 may control input/output of data stored in the memory 1300.

Data information for operation of the processor 1200 and/or operation of the display module 1100 may be stored in the memory 1300. In some example embodiments, the memory 1300 may store selection data to sense a characteristic of a pixel within the display module 1100. When the processor 1200 executes an application stored in the memory 1300, an image data signal and/or an input control signal may be transferred or transmitted to the display module 1100, and the display module 1100 may process the received signal and may output image information through a display screen. For example, the display module 1100 may receive image data from the memory 1300, and may output the received image data.

According to some example embodiments, the display module 1100 may be the display device 10 described with reference to FIGS. 1 to 8.

The power source module 1400 may include a power source supply module such as a power source adapter or a battery device, and a power source conversion module that converts a power source supplied by the power source supply module to generate a power source for operation of the electronic device 1000.

The electronic device 1000 may further include an input module 1500, a non-image output module 1600, and/or a communication module 1700.

The input module 1500 may provide input information to the processor 1200 and/or the display module 1100. The input module 1500 may include a physical button, a keyboard, a microphone, and various sensor modules. Examples of sensor modules may include a touch sensor, a pressure sensor, a distance sensor, a position sensor, a digitizer, a motion recognition sensor, a camera sensor, a light receiving sensor, a photoelectric conversion sensor, a temperature sensor, and a biometric sensor (e.g., a blood pressure sensor, a blood sugar sensor, an electrocardiogram sensor, or a heart rate sensor).

The non-image output module 1600 may receive information other than an image received from the processor 1200 and provide the information to the user. An example of the non-image output module 1600 may include an acoustic module, a haptic module, a light emitting module, or the like, and may include a functional module unique to another electronic device (e.g., a cooling module of a refrigerator).

The communication module 1700 may be a module configured for transmitting and receiving information between the electronic device 1000 and an external device, and may include a receiving portion and a transmitting portion. The communication module 1700 may include various wireless communication modules such as a mobile communication module, a Wi-Fi module, and a Bluetooth module, or various wired communication modules.

At least one of the components of the electronic device 1000, as described above, may be included within the display device, according to some example embodiments described above. Some of the individual modules functionally included within one module may be included within the display device, while the others may be provided separately from the display device. For example, the display device may include the display module 1100, and the processor 1200, the memory 1300, and the power source module 1400 may be provided in forms of other devices within the electronic device 1000 other than the display device.

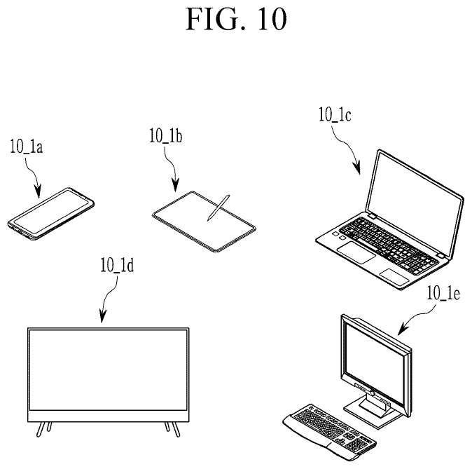

FIGS. 10 to 12 are schematic diagrams of electronic devices according to some example embodiments. FIGS. 10 to 12 illustrate examples of various electronic devices that include the display device according to some example embodiments.

FIG. 10 illustrates examples of the electronic devices including a smartphone 10_1a, a tablet PC 10_1b, a laptop 10_1c, a TV 10_1d, and a desk monitor 10_1e.

The smartphone 10_1a may include an input module such as a touch sensor and a communication module in addition to the display module 1100. The smartphone 10_1a may process information received through the communication module or another input module to display information through a display module of the display device.

The tablet PC 10_1b, the laptop 10_1c, the TV 10_1d, and the desk monitor 10_1e may include a display module and an input module similar to the smartphone 10_1a, and may further include a communication module.

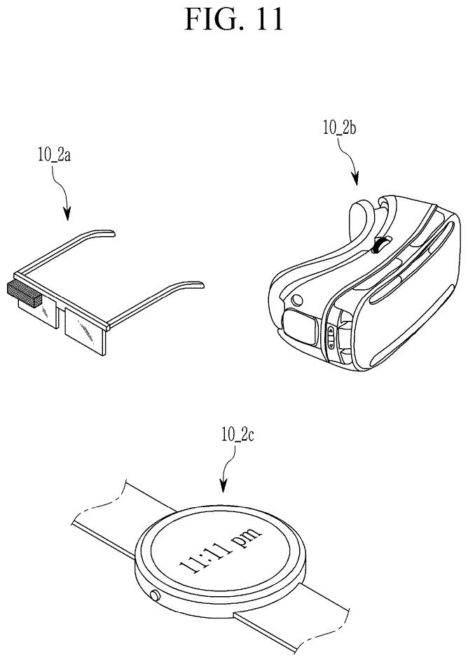

FIG. 11 illustrates the electronic device including the display module as a wearable electronic device. The wearable electronic device may be smart glasses 10_2a, a head mounted display 10_2b, a smartwatch 10_2c, or the like.

The smart glasses 10_2a and the head mounted display 10_2b may include a display module that emits a display image and a reflector that reflects the emitted display image to provide the reflected image to the user's eye so that they provide a virtual reality screen or an augmented reality screen to the user.

The smartwatch 10_2c may include a biometric sensor as an input device, and may provide biometric information recognized by the biometric sensor to the user through a display module.

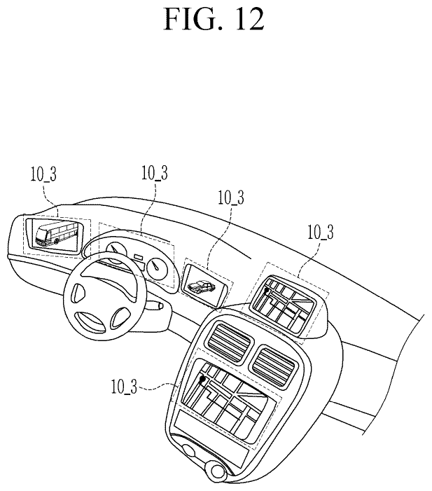

FIG. 12 illustrates an example where the electronic device including the display module is used in a vehicle. For example, an electronic device 10_3 may be used in a dashboard, a center fascia, or the like of the vehicle, or may be used in a center information display (CID) disposed on the dashboard of the vehicle, a room mirror display replacing a side mirror of the vehicle, or the like.

The electronic device including the display device, according to some example embodiments disclosed herein, may include devices that include display screens such as a billboard, an electronic board, and a game console, and various home appliances that display information through a display module such as a refrigerator, a washing machine, a dryer, an air conditioner, and a robot vacuum cleaner. In addition, when the display module has a function of transmitting light, example embodiments disclosed herein may be applied to an electronic device such as a smart window or a transparent display device that displays a background and a display image together. A type of the electronic device according to example embodiments is not limited to the above-described examples, and application of various other electronic devices not exemplified may also be possible.

The display device, according to some example embodiments, may be applied to various electronic devices. The electronic device, according to some example embodiments, may include the display device described above, and may further include a module or a device having additional functions in addition to the display device.

As described herein, any devices, systems, modules, portions, units, controllers, circuits, and/or portions thereof according to any of the example embodiments, and/or any portions thereof (including, without limitation, the gate driver 20, the data driver 30, the display panel 40, the timing controller 50, the sensing circuit 60, the display module 1100, the processor 1200, the memory 1300, the power source module 1400, the input module 1500, the non-image output module 1600, the communication module 1700, any portion thereof, or the like) may include, may be included in, and/or may be implemented by one or more instances of processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a graphics processing unit (GPU), an application processor (AP), a digital signal processor (DSP), a microcomputer, a field programmable gate array (FPGA), a System-on-Chip (SoC), a programmable logic unit, a microprocessor, an application-specific integrated circuit (ASIC), a neural network processing unit (NPU), an Electronic Control Unit (ECU), an Image Signal Processor (ISP), and the like. In some example embodiments, the processing circuitry may include a non-transitory computer readable storage device (e.g., a memory), for example a solid state drive (SSD), storing a program of instructions, and a processor (e.g., CPU) configured to execute the program of instructions to implement the functionality and/or methods performed by some or all of any devices, systems, modules, portions, units, controllers, circuits, and/or portions thereof according to any of the example embodiments. The processing circuitry may include electrical components such as at least one of transistors, resistors, capacitors, etc. The processing circuitry may include electrical components such as logic gates including at least one of AND gates, OR gates, NAND gates, NOT gates, etc.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

What is claimed is:

1. A display device comprising:
a plurality of pixels connected to at least one gate line extending in a first direction and at least one data line extending in a second direction different from the first direction;
a data driver configured to transmit a data signal corresponding to each of the plurality of pixels through the at least one data line;
a sensing circuit configured to receive a plurality of sensing signals output from the plurality of pixels through a plurality of sensing lines in response to the data signal; and
a timing controller configured to control the data driver to perform a sensing operation to sense a characteristic of a selected pixel based on selection data, the selection data indicating the selected pixel corresponding to each of the at least one gate line,
wherein the plurality of pixels are connected to a first gate line of the at least one gate line, at least two pixels of the plurality of pixels are connected to a sensing line, and the at least two pixels are adjacent to each other in the first direction.

2. The display device of claim 1, wherein each pixel of the plurality of pixels includes a plurality of sub-pixels, and
the timing controller is configured to control the data driver to transmit a first data signal corresponding to a first measurement criterion to a first sub-pixel and to apply a second data signal corresponding to a black voltage to a plurality of non-selected sub-pixels connected to the first gate line, the selection data indicating the first sub-pixel as the selected pixel corresponding to the first gate line.

3. The display device of claim 2, wherein the sensing circuit is configured to receive a first sensing signal that is output from the first sub-pixel based on the first data signal through a first sensing line connected to the first sub-pixel, and generate sensing data based on the first sensing signal.

4. The display device of claim 3, wherein the sensing circuit is configured to transmit the sensing data to the timing controller, and the timing controller is configured to control the data driver to perform the sensing operation on the selected pixel corresponding to a second gate line adjacent to the first gate line.

5. The display device of claim 1, wherein a first pixel among the at least two pixels adjacent to each other in the first direction is on a first side of the sensing line, and a second pixel among the at least two pixels is on a second side of the sensing line.

6. The display device of claim 1, wherein a first pixel of the at least two pixels adjacent to each other in the first direction and a second pixel of the at least two pixels are on a first side of the sensing line.

7. The display device of claim 1, wherein each of the plurality of pixels includes a first sub-pixel corresponding to a first color, a second sub-pixel corresponding to a second color, and a third sub-pixel corresponding to a third color,
a first pixel of the at least two pixels adjacent to each other in the first direction is disposed at a first side of the sensing line and a second pixel of the at least two pixels is disposed at a second side of the sensing line, and the first sub-pixel, the second sub-pixel, and the third sub-pixel of the first pixel and the first sub-pixel, the second sub-pixel, and the third sub-pixel of the second pixel are symmetric with respect to the sensing line.

8. The display device of claim 7, wherein the first color, the second color, and the third color are red, green, and blue, respectively.

9. The display device of claim 1, wherein each sensing line of the plurality of sensing lines is connected to the sensing circuit through a sensing pad corresponding to each sensing line of the plurality of sensing lines.

10. The display device of claim 1, wherein the display device is configured to perform the sensing operation during a vertical blank period in which the plurality of pixels do not display an image.

11. The display device of claim 1, wherein the sensing circuit includes,
an analog front end connected to the plurality of sensing lines, the analog front end being configured to receive a sensing signal and convert the sensing signal into a sensing voltage; and
an analog-to-digital converter connected to the analog front end and configured to receive the sensing voltage as an analog signal and generate sensing data as a digital signal.

12. A display device comprising:
a plurality of pixels that are connected to at least one gate line extending in a first direction, at least one data line extending in a second direction different from the first direction, and at least one sensing line extending in the second direction, the plurality of pixels being connected to a first gate line of the at least one gate line, and at least two pixels of the plurality of pixels being adjacent each other in the first direction and being connected to the at least one sensing line;
a timing controller configured to perform a sensing operation to sense a characteristic of a selected pixel based on selection data, the selection data indicating the selected pixel corresponding to each of the at least one gate line; and
a data driver configured to transmit a first data signal corresponding to a first measurement criterion to the selected pixel based on the selection data and apply a second data signal corresponding to a black voltage to a plurality of non-selected pixels.

13. The display device of claim 12, further comprising a sensing circuit configured to receive a sensing signal that is output from the selected pixel in response to the first data signal, generate sensing data based on the sensing signal, and transmit the sensing data to the timing controller.

14. The display device of claim 13, wherein the sensing circuit includes,
an analog front end connected to the at least one sensing line, the analog front end being configured to receive the sensing signal and convert the sensing signal into a sensing voltage; and
an analog-to-digital converter connected to the analog front end and configured to receive the sensing voltage as an analog signal and generate the sensing data as a digital signal.

15. The display device of claim 12, wherein each of the plurality of pixels includes a first sub-pixel corresponding to a first color, a second sub-pixel corresponding to a second color, and a third sub-pixel corresponding to a third color,
a first pixel of the at least two pixels adjacent to each other in the first direction is on a first side of the at least one sensing line and a second pixel of the at least two pixels is on a second side of the at least one sensing line, and
the first sub-pixel, the second sub-pixel, and the third sub-pixel of the first pixel and the first sub-pixel, the second sub-pixel, and the third sub-pixel of the second pixel are symmetric with respect to the at least one sensing line.

16. The display device of claim 15, wherein the first color, the second color, and the third color are red, green, and blue, respectively.

17. The display device of claim 12, wherein the display device is configured to perform the sensing operation during a vertical blank period in which the plurality of pixels do not display an image.

18. An electronic device comprising:
a display module that is connected to at least one gate line extending in a first direction, at least one data line extending in a second direction different from the first direction, and at least one sensing line extending in the second direction, the display module including a plurality of pixels connected to a first gate line of the at least one gate line, and at least two pixels of the plurality of pixels being adjacent each other in the first direction and being connected to the at least one sensing line;
a memory configured to store selection data indicating a selected pixel corresponding to each of the at least one gate line; and
a processor configured to transmit a first data signal corresponding to a first measurement criterion to the selected pixel based on the selection data and apply a second data signal corresponding to a black voltage to a plurality of non-selected pixels to perform a sensing operation to sense a characteristic of the selected pixel.

19. The electronic device of claim 18, wherein a first pixel of the at least two pixels adjacent each other in the first direction is on a first side of the at least one sensing line, and a second pixel of the at least two pixels is on a second side of the at least one sensing line.

20. The electronic device of claim 18, wherein a first pixel of the at least two pixels adjacent each other in the first direction and a second pixel of the at least two pixels are on a first side of the at least one sensing line.
